(19) United States
(12) Patent Application Publication
(10) Pub. No.: US 2015/0248860 A1
(43) Pub. Date: Sep. 3, 2015

(54) DISPLAY SYSTEM

(71) Applicant: Ignis Innovation Inc., Waterloo (CA)

(72) Inventors: Arokia Nathan, Cambridge (GB); Gholamreza Chaji, Waterloo (CA); Joseph Marcel Dionne, Waterloo (CA)

(21) Appl. No.: 14/630,906

(22) Filed: Feb. 25, 2015

Related U.S. Application Data
(60) Provisional application No. 61/946,427, filed on Feb. 28, 2014.

(51) Int. Cl. G09G 3/32

(52) U.S. Cl. CPC G09G 3/3208; G09G 3/3258; G09G 3/3291; G09G 3/3233; G09G 2300/0852; G09G 2300/0819; G09G 2310/0256; G09G 2310/0254; G09G 2320/045; G09G 2320/048; G09G 2330/027

(57) ABSTRACT

A method of recovering a display having a plurality of pixels, each having a light emitting device and a driving transistor for driving the light emitting device. The driving transistor and the light emitting device are coupled in series between a first power supply and a second power supply. The method illuminates the semiconductor device while negatively biasing the pixel circuit with a recovery voltage different from an image programming voltage. The illuminating may follow a first cycle implementing an image display operation that includes programming the pixel circuit for a valid image and driving the pixel circuit to emit light according to the programming.

### CROSS REFERENCE TO RELATED APPLICATION

This application claims the benefit of U.S. Provisional Patent Application No. 61/946,427, filed Feb. 28, 2014 (Attorney Docket No. 058161-000028PL01), which is hereby incorporated by reference in its entirety.

### FIELD OF INVENTION

The present invention relates to display devices, and more specifically to a pixel circuit, a light emitting device display and an operation technique for the light emitting device display.

### BACKGROUND OF THE INVENTION

Electro-luminance displays have been developed for a wide variety of devices, such as, personal digital assistants (PDAs) and cell phones. In particular, active-matrix organic light emitting diode (AMOLED) displays with amorphous silicon (a-Si), poly-silicon, organic, or other driving backplane have become more attractive due to advantages, such as feasible flexible displays, its low cost fabrication, high resolution, and a wide viewing angle.

An AMOLED display includes an array of rows and columns of pixels, each having an organic light emitting diode (OLED) and backplane electronics arranged in the array of rows and columns. Since the OLED is a current driven device, there is a need to provide an accurate and constant drive current.

However, the AMOLED displays exhibit non-uniformities in luminance on a pixel-to-pixel basis, as a result of pixel degradation. Such degradation includes, for example, aging caused by operational usage over time (e.g., threshold shift, OLED aging). Depending on the usage of the display, different pixels may have different amounts of the degradation. There may be an ever-increasing error between the required brightness of some pixels as specified by luminance data and the actual brightness of the pixels. The result is that the desired image will not show properly on the display.

Therefore, there is a need to provide a method and system that is capable of recovering displays.

### SUMMARY OF THE INVENTION

It is an object of the invention to provide a method and system that obviates or mitigates at least one of the disadvantages of existing systems.

According to an aspect of the present invention there is provided a method of recovering a display having a plurality of pixels, each having a light emitting device and a driving transistor for driving the light emitting device. The driving transistor and the light emitting device are coupled in series between a first power supply and a second power supply. The method illuminates the semiconductor device while negatively biasing the pixel circuit with a recovery voltage different from an image programming voltage. The illuminating may follow a first cycle implementing an image display operation that includes programming the pixel circuit for a valid image and driving the pixel circuit to emit light according to the programming.

In one implementation, the illumination is with light in the blue or ultraviolet range. In another implementation, the illumination is generated by said semiconductor device itself. The recovery voltage is based on the performance or aging history of the pixel circuit, and the illumination and the recovery voltage may be either constant or pulsed.

Illuminating the semiconductor device while negatively biasing the pixel circuit with a recovery voltage preferably produces a negative induced VT voltage shift in the semiconductor device. The negative induced VT shift may be followed by a positive induced VT shift to minimize the gap between the performances of different pixel circuits, and the negative induced VT shift and the positive induced VT shift may be repeated multiple times.

### BRIEF DESCRIPTION OF THE DRAWINGS

These and other features of the invention will become more apparent from the following description in which reference is made to the appended drawings wherein:

FIG. 1 is a diagram showing an example of a pixel circuit in accordance with an embodiment of the present invention;

FIG. 2 is a timing diagram showing exemplary waveforms applied to the pixel circuit of FIG. 1;

FIG. 3 is a diagram showing an example of a display system having a mechanism for a relaxation driving scheme, in accordance with an embodiment of the present invention;

FIG. 4 is a timing diagram showing exemplary waveforms applied to the display system of FIG. 3;

FIG. 5 is a timing diagram showing exemplary frame operations for a recovery driving scheme in accordance with an embodiment of the present invention;

FIG. 6 is a diagram showing an example of pixel components to which the recovery driving scheme of FIG. 5 is applied;

FIG. 7 is a timing diagram showing one example of recovery frames for the recovery driving scheme of FIG. 5;

FIG. 8 is a timing diagram showing another example of recovery frames for the recovery driving scheme of FIG. 5; and

FIG. 9 is a timing diagram showing an example of a driving scheme in accordance with an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

Embodiments of the present invention are described using an active matrix light emitting display and a pixel that has an organic light emitting diode (OLED) and one or more thin film transistors (TFTs). However, the pixel may include a light emitting device other than OLED, and the pixel may include transistors other than TFTs. The transistors of the pixel and display elements may be fabricated using poly silicon, nano/micro crystalline silicon, amorphous silicon, organic semiconductors technologies (e.g., organic TFTs), NMOS technology, CMOS technology (e.g., MOSFET), metal oxide technologies, or combinations thereof.

In the description, “pixel circuit” and “pixel” are used interchangeably. In the description, “signal” and “line” may be used interchangeably. In the description, “connect (or connected)” and “couple (or coupled)” may be used interchangeably, and may be used to indicate that two or more elements are directly or indirectly in physical or electrical contact with each other.

In the embodiments, each transistor has a gate terminal, a first terminal and a second terminal where the first terminal (the second terminal) may be, but not limited to, a drain terminal or a source terminal (source terminal or drain terminal).

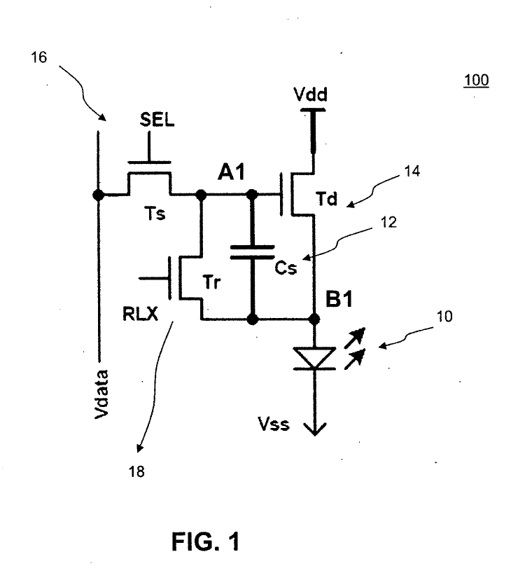

A relaxation driving scheme for recovering pixel components is now described in detail. FIG. 1 illustrates an example of a pixel circuit in accordance with an embodiment of the present invention. The pixel circuit 100 of FIG. 1 employs a relaxation driving scheme for recovering the aging of the pixel elements. The pixel circuit 100 includes an OLED 10, a storage capacitor 12, a driving transistor 14, a switch transistor 16, and a relaxation circuit 18. The storage capacitor 12 and the transistors 14 and 16 form a pixel driver for driving the OLED 10. In FIG. 1, the relaxation circuit 18 is implemented by a transistor 18, hereinafter referred to as transistor 18 or relaxation (switch) transistor 18. In FIG. 1, the transistors 14, 16, and 18 are n-type TFTs.

An address (select) line SEL, a data line Vdata for providing a programming data (voltage) Vdata to the pixel circuit, power supply lines Vdd and Vss, and a relaxation select line RLX for the relaxation are coupled to the pixel circuit 100. Vdd and Vss may be controllable (changeable).

The first terminal of the driving transistor 14 is coupled to the voltage supply line Vdd. The second terminal of the driving transistor 14 is coupled to the anode electrode of the OLED 10 at node B1. The first terminal of the switch transistor 16 is coupled to the data line Vdata. The second terminal of the switch transistor 16 is coupled to the gate terminal of the driving transistor at node A1. The gate terminal of the switch transistor 16 is coupled to the select line SEL. The storage capacitor is coupled to node A1 and node B1. The relaxation switch transistor 18 is coupled to node A1 and node B1. The gate terminal of the relaxation switch transistor 18 is coupled to RLX.

In a normal operation mode (active mode), the pixel circuit 100 is programmed with the programming data (programming state), and then a current is supplied to the OLED 10 (light emission/driving state). In the normal operation mode, the relaxation switch transistor 18 is off. In a relaxation mode, the relaxation switch transistor 18 is on so that the gate-source voltage of the driving transistor 16 is reduced.

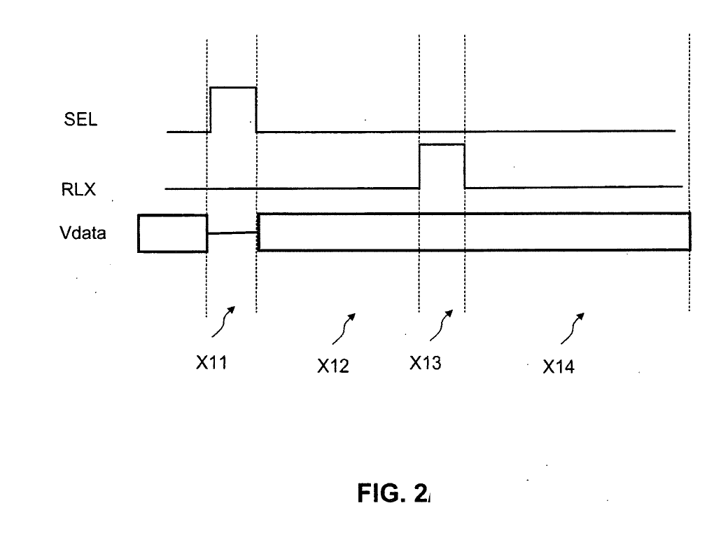

FIG. 2 illustrates a driving scheme for the pixel circuit 100 of FIG. 1. The operation for the pixel circuit 100 of FIG. 1 includes four operation cycles X11, X12, X13 and X14. X11, X12, X13 and X14 may form a frame. Referring to FIGS. 1-2, during the first operation cycle X11 (programming cycle), SEL signal is high and the pixel circuit 100 is programmed for a wanted brightness with Vdata. During the second operation cycle X12 (driving cycle), the driving transistor 12 provides current to the OLED 10. During the third operation cycle X13, RLX signal is high and the gate-source voltage of the driving transistor 14 becomes zero. As a result, the driving transistor 14 is not under stress during the fourth operating cycle X14. Thus the aging of the driving transistor 14 is suppressed.

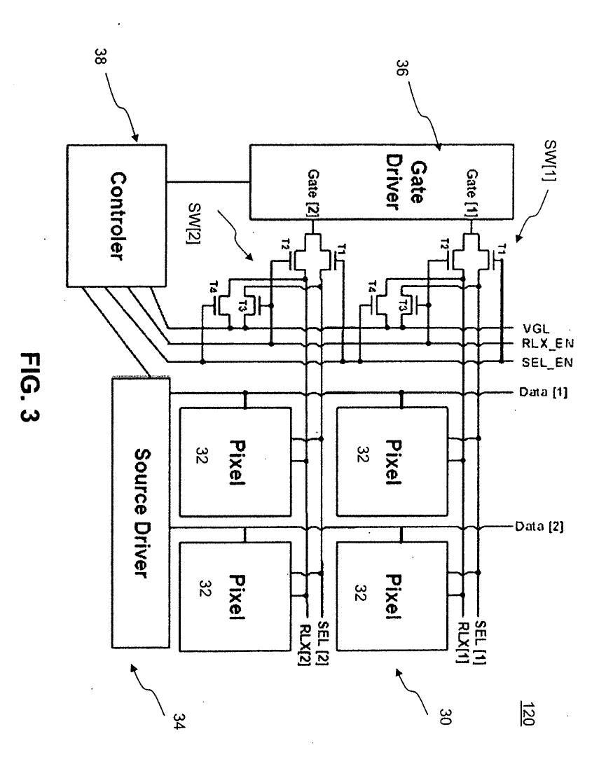

FIG. 3 illustrates an example of a display system having a mechanism for a relaxation driving scheme, in accordance with an embodiment of the present invention. The display system 120 includes a display array 30. The display array 30 is an AMOLED display where a plurality of pixel circuits 32 are arranged in rows and columns. The pixel circuit 32 may be the pixel circuit 100 of FIG. 1. In FIG. 3, four pixel circuits 32 are arranged with 2 rows and 2 columns. However, the number of the pixel circuits 32 is not limited to four and may vary.

In FIG. 3, SEL[i] represents an address (select) line for the ith row (i=1, 2, . . .), which is shared among the pixels in the ith row. In FIG. 3, RLX[i] represents a relaxation (select) line for the ith row, which is shared among the pixels in the ith row. In FIG. 3, Datab[j] represents a data line for the jth column (j=1, 2, . . .), which is shared among the pixels in the jth column. SEL[i] corresponds to SEL of FIG. 1. RLX[i] corresponds to RLX of FIG. 1. Data[j] corresponds to Vdata of FIG. 1.

Data[j] is driven by a source driver 34. SEL[i] and RLX[i] are driven by a gate driver 36. The gate driver 36 provides a gate (select) signal Gate[i] for the ith row. SEL[i] and RLX[i] share the select signal Gate[i] output from the gate driver 36 via a switch circuit SW[i] for the ith row.

The switch circuit SW[i] is provided to control a voltage level of each SEL[i] and RLX[i]. The switch circuit SW[i] includes switch transistors T1, T2, T3, and T4. Enable lines SEL_EN and RLX_EN and a bias voltage line VGL are coupled to the switch circuit SW[i]. In the description, “enable signal SEL_EN” and “enable line SEL_EN” are used interchangeably. In the description, “enable signal RLX_EN” and “enable line RLX_EN” are used interchangeably. A controller 38 controls the operations of the source driver 34, the gate driver 36, SEL_EN, RLX_EN and VGL.

The switch transistor T1 is coupled to a gate driver's output (e.g., Gate[1], Gate [2]) and the select line (e.g., SEL[1], SEL[2]). The switch transistor T2 is coupled to the gate driver's output (e.g., Gate[1], Gate [2]) and the relaxation select line (e.g., RLX[1], RLX[2]). The switch transistor T3 is coupled to the select line (e.g., SEL[1], SEL[2]) and VGL. The switch transistor T4 is coupled to the relaxation select line (e.g., RLX[1], RLX[2]) and VGL. VGL line provides the off voltage of the gate driver 36. VGL is selected so that the switches are Off.

The gate terminal of the switch transistor T1 is coupled to the enable line SEL_EN. The gate terminal of the switch transistor T2 is coupled to the enable line RLX_EN. The gate terminal of the switch transistor T3 is coupled to the enable line RLX_EN. The gate terminal of the switch transistor T4 is coupled to the enable line SEL_EN.

The display system employs a recovery operation including the relaxation operation for recovering the display after being under stress and thus reducing the temporal non-uniformity of the pixel circuits.

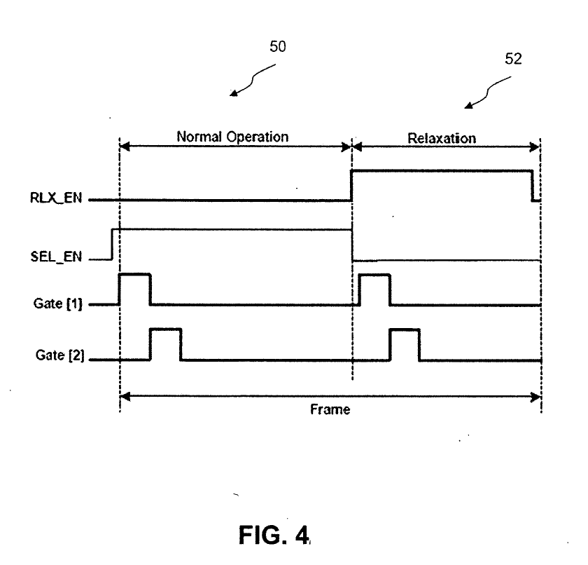

FIG. 4 illustrates a driving scheme for the display system 120 of FIG. 3. Referring to FIGS. 3-4, each frame time operation includes a normal operation cycle 50 and a relaxation cycle 52. The normal operation cycle 50 includes a programming cycle and a driving cycle as well understood by one of ordinary skill in the art. In the normal operation cycle 50, SEL_EN is high so that the switch transistors T1 and T4 are on, and RLX_EN is low so that the switch transistors T2 and T3 are off. In the normal operation cycle 50, SEL [i] (i: the row number, i=1, 2, . . .) is coupled to the gate driver 36 (Gate[i]) via the switch transistor T1, and RLX[i] is coupled to VGL (the off voltage of the gate driver) via the transistor T4. The gate driver 36 sequentially outputs a select signal for each row (Gate[1], Gate [2]). Based on the select signal and a programming data (e.g., Data [1], Data [2]), the display system 120 programs a selected pixel circuit and drives the OLED in the selected pixel circuit.

In the relaxation cycle 52, SEL_EN is low, and RLX_EN is high. The switch transistors T2 and T3 are on, and the switch transistors T1 and T4 are off. SEL[i] is coupled to VGL via the switch transistor T3, and RLX[i] is coupled to the gate driver 36 (Gate [i]) via the switch transistor T2. As a result, the relaxation switch transistor (e.g., 18 of FIG. 1) is on. The switch transistor coupled to the data line (e.g., 16 of FIG. 1) is off. The gate-source voltage of the driving transistor (e.g., 14 of FIG. 1) in the pixel circuit 32 becomes, for example, zero.

In the above example, the normal operation and the relaxation operation are implemented in one frame. In another example, the relaxation operation may be implemented in a different frame. In a further example, the relaxation operation may be implemented after an active time on which the display system displays a valid image.

A recovery driving scheme for improving pixel component stabilities is now described in detail. The recovery driving scheme uses a recovery operation to improve the display lifetime, including recovering the degradation of pixel components and reducing temporal non-uniformity of pixels. The recovery driving scheme may include the relaxation operation (FIGS. 1-4). The recovery operation may be implemented after a active time or in an active time.

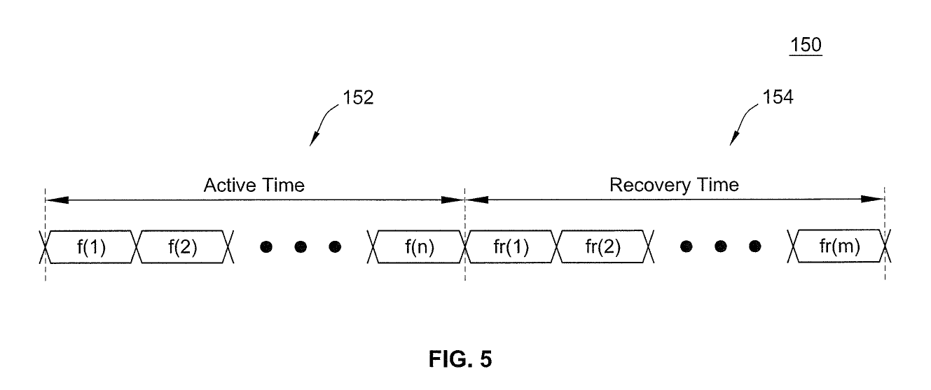

FIG. 5 illustrates a recovery driving scheme for a display system in accordance with an embodiment of the present invention. The recovery driving scheme 150 of FIG. 5 includes an active time 152 and a recovery time 154 after the active time 152. In FIG. 5, “f(k)” (k=1, 2, . . . , n) represents an active frame. In FIG. 5, “fr(1)” (l=1, 2, . . . , m) represents a recovery frame. During the active time 152, the active frames f(1), f(2), . . . , f(n) are applied to a display. During the recovery time 154, the recovery frames fr(1), fr(2), . . . , fr(m) are applied to the display. The recovery driving scheme 150 is applicable to any displays and pixel circuits.

The active time 152 is a normal operation time on which the display system displays a valid image. Each active frame includes a programming cycle for programming a pixel associated with the valid image and a driving cycle for driving a light emitting device. The recovery time 154 is a time for recovering the display and not for showing the valid image.

For example, after a user turns off the display (i.e., turns off a normal image display function or mode), the recovery frames fr(1), . . . , fr(m) are applied to the display to turn over the pixel's components aging. The aging of the pixel elements includes, for example, threshold voltage shift of transistors and OLED luminance and/or electrical degradation. During the recovery frame fr(1), one can operate the display in the relaxation mode (described above) and/or a mode of reducing OLED luminance and electrical degradation.

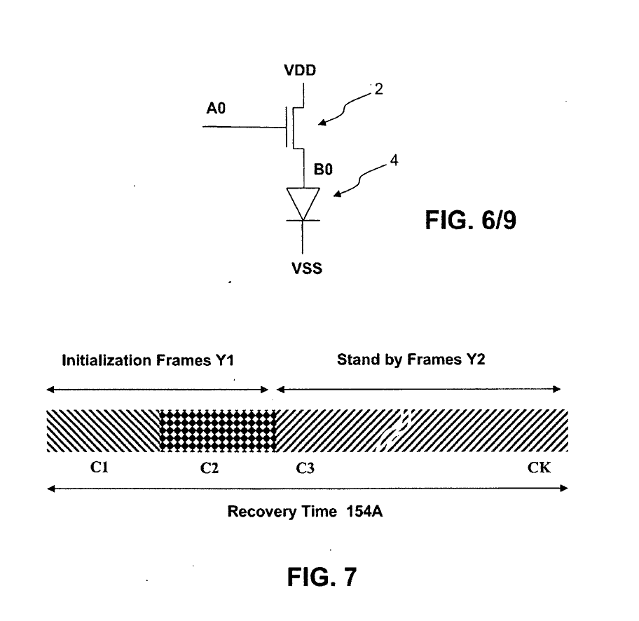

FIG. 6 illustrates one example of pixel components to which the recovery driving scheme of FIG. 5 is applied. As shown in FIG. 6, a pixel circuit includes a driving transistor 2 and OLED 4, being coupled in series between a power supply VDD and a power supply VSS. In FIG. 6. the driving transistor 2 is coupled to the power supply VDD. The OLED 4 is coupled to the driving transistor at node B0 and the power supply line VSS. The gate terminal of the driving transistor 2, i.e., node A0, is charged by a programming voltage. The driving transistor 2 provides a current to the OLED 4.

At least one of VSS and VDD is controllable (changeable). In this example, VSS line is a controllable voltage line so that the voltage on VSS is changeable. VDD line may be a controllable voltage line so that the voltage on VDD is changeable. VSS and VDD lines may be shared by other pixel circuits.

It would be well understood by one of ordinary skill in the art that the pixel circuit may include components other than the driving transistor 2 and the OLED 4, such as a switch transistor for selecting the pixel circuit and providing a programming data on a data line to the pixel circuit, and a storage capacitor in which the programming data is stored.

FIG. 7 illustrates one example of recovery frames associated with the recovery deriving scheme of FIG. 5. The recovery time 154A of FIG. 7 corresponds to the recovery time 154 of FIG. 5, and includes initialization frames Y1 and stand by frames Y2. The initialization frames Y1 include frames C1 and C2. The stand by frames Y2 include frames C3, . . . , CK. The stand by frames Y2 are normal stand by frames.

Referring to FIGS. 6-7, during the first frame C1 in the initialization frames Y1, the display is programmed with a high voltage (VP_R) while VSS is high voltage (VSS₁₃ R) and VDD is at VDD_R. As a result, node A0 is charged to VP_R and node B0 is charged to VDD_R. Thus, the voltage at OLED 4 will be—(VSS_R-VDD_R). Considering that VSS_R is larger than VDD_R, the OLED 4 will be under negative bias which will help the OLED 4 to recover.

VSS_R is higher than VSS at a normal image programming and driving operation. VP-R may be higher than that of a general programming voltage VP.

During the second frame C2 in the initialization frames Y1, the display is programmed with gray zero while VDD and VSS preserve their previous value. At this point, the gate-source voltage (VGS) of the driving transistor 2 will be—VDD_R. Thus, the driving transistor 2 will recover from the aging. Moreover, this condition will help to reduce the differential aging among the pixels, by balancing the aging effect. If the state of each pixel is known, one can use different voltages instead of zero for each pixel at this stage. As a result, the negative voltage apply to each pixel will be different so that the recovery will be faster and more efficient.

Each pixel may be programmed with different negative recovery voltage, for example, based on the ageing profile (history of the pixel's aging) or a look up table.

In FIG. 7, the frame C2 is located after the frame C1. However, in another example, the frame C2 may be implemented before the frame C1.

The same technique can be applied to a pixel in which the OLED 4 is coupled to the drain of the driving transistor 2 as well.

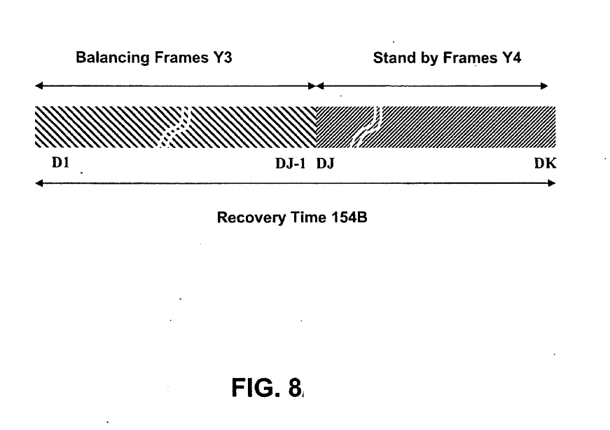

FIG. 8 illustrates another example of recovery frames associated with the recovery deriving scheme of FIG. 5. The recovery time 154B of FIG. 8 corresponds to the recovery time 154 of FIG. 5, and includes balancing frames Y3 and the stand by frames Y4. The stand by frames Y4 include frames DJ, . . . , Dk. The stand by frames Y4 correspond to the stand by frames Y3 of FIG. 7. The balancing frames Y3 include frames D1, . . . , DJ−1.

During the recovery time 154B, the display runs on uncompensated mode for a number of frames D1−DJ−1 that can be selected based on the ON time of the display. In this mode, the part that aged more start recovering and the part that aged less will age. This will balance the display uniformity over time.

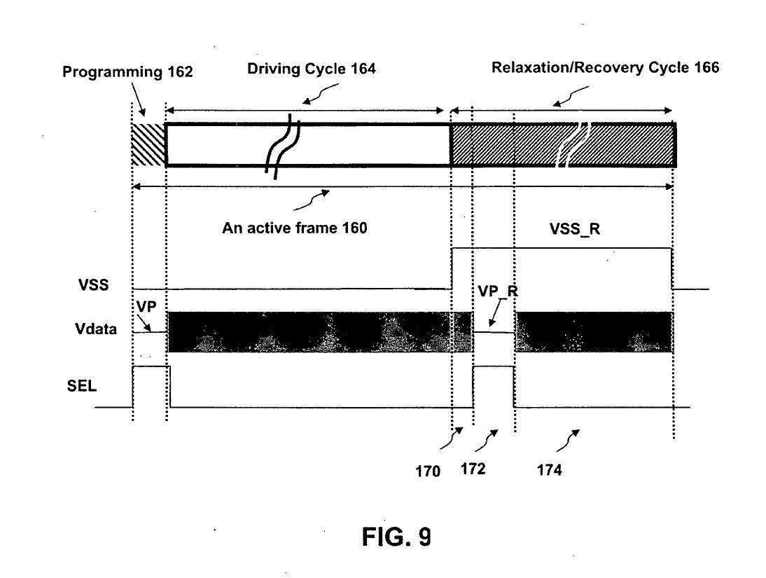

In the above example, the display has the recovery time (154 of FIG. 5) after the active time (152 of FIG. 5). However, in another example, an active frame is divided into programming, driving and relaxation/recovery cycles. FIG. 9 illustrates a further example of a driving scheme for a display in accordance with an embodiment of the present invention. The active frame 160 of FIG. 9 includes a programming cycle 162, a driving cycle 164, and a relaxation/recovery cycle 166. The driving scheme of FIG. 9 is applied to a pixel having the driving transistor 2 and the OLED 4 of FIG. 6.

Referring to FIGS. 6 and 9, during the programming cycle 162, the pixel is programmed with a required programming voltage VP. During the driving cycle 164, the driving transistor 2 provides current to the OLED 4 based on the programming voltage VP. After the driving cycle 164, the relaxation/recovery cycle 166 starts. During the relaxation/recovery cycle 166, the degradation of pixel components is recovered. In this example, the display system implements a recovery operation formed by a first operation cycle 170, a second operation cycle 172 and a third operation cycle 174.

During the first operation cycle 170, VSS goes to VSS_R, and so node B0 is charged to VP-VT (VT: threshold voltage of the driving transistor 4). During the first operation cycle 172, node A0 is charged to VP_R and so the gate voltage of the driving transistor 2 will be—(VP-VT-VP_R). As a result, the pixel with larger programming voltage during the driving cycle 164 will have a larger negative voltage across its gate-source voltage. This will results in faster recovery for the pixels at higher stress condition.

In another example, the display system may be in the relaxation mode during the relaxation/recovery cycle 166.

In a further example, the history of pixels' aging may be used. If the history of the pixel's aging is known, each pixel can be programmed with different negative recovery voltage according to its aging profile. This will result in faster and more effective recovery. The negative recovery voltage is calculated or fetch from a look up table, based on the aging of the each pixel. In the above embodiments, the pixel circuits and display systems are described using n-type transistors. However, one of ordinary skill in the art would appreciate that the n-type transistor in the circuits can be replaced with a p-type transistor with complementary circuit concept. One of ordinary skill in the art would appreciate that the programming, driving and relaxation techniques in the embodiments are also applicable to a complementary pixel circuit having p-type transistors.

1. Some semiconductor devices experience stress annealing or recovery under certain bias, temperature and illumination.

2. For example, oxide semiconductor devices have negative threshold voltage shift under negative bias and illumination condition

3. Here higher energy photons (e.g., in the blue or UV range) can accelerate the negative threshold voltage shift.

Therefore, in one aspect of this invention, a semiconductor device is negatively biased while it is under illumination to induce negative threshold voltage shift in the device.

In another aspect of this invention, a semiconductor device can generate the light by itself to be used for recovery process.

In another aspect of the invention, the semiconductor device can be an array of the pixel and each pixel can be negatively biased and left under illumination.

In another aspect of the invention, the pixel can be biased with different biased levels based on a signal representing the performance of the pixel or aging history of the pixel. The signal can be the stress history, a current level for a given voltage, a voltage for a given current, or any other type of signal representing the pixel performance.

In one aspect of the invention, constant illumination and/or bias conditions are used for recovery.

In another aspect of the invention, pulse illumination and/or bias conditions are used for recovery.

In another aspect of the invention, the negative induced VT shift operation can be followed by stress condition with positive induced VT shift to minimize the gap between the performances of different pixels.

In another aspect of the invention, the negative induced VT shift and positive induced VT shift operations can be repeated multiple times.

Another aspect of this invention will be to use the bias illumination condition to improve non-uniformities associated with the solid state devices, including both initial non-uniformities and those due to aging.

One or more currently preferred embodiments have been described by way of example. It will be apparent to persons skilled in the art that a number of variations and modifications can be made without departing from the scope of the invention as defined in the claims.

1. A method of recovering a display having a plurality of pixels, each having a light emitting device and a driving transistor for driving the light emitting device, the driving transistor and the light emitting device being coupled in series between a first power supply and a second power supply, the method comprising:
illuminating the semiconductor device while negatively biasing the pixel circuit with a recovery voltage different from an image programming voltage.

2. The method of claim 1 in which the illumination is with light in the blue or ultraviolet range.

3. The method of claim 1 in which illuminating the semiconductor device while negatively biasing the pixel circuit with a recovery voltage produces a negative induced VT voltage shift in the semiconductor device.

4. The method of claim 3 in which the negative induced VT shift is followed by a positive induced VT shift to minimize the gap between the performances of different pixel circuits.

5. The method of claim 4 in which the negative induced VT shift and the positive induced VT shift are repeated multiple times.

6. The method of claim 1 in which the illumination is generated by said semiconductor device itself.

7. The method of claim 1 in which the recovery voltage is based on the performance or aging history of the pixel circuit.

8. The method of claim 1 in which the illumination and the recovery voltage are substantially constant.

9. The method of claim 1 in which the illumination and the recovery voltage are pulses.

10. The method of claim 1 in which non-uniformities associated with the plurality of pixels are improved.

11. A method for a display including a pixel circuit that includes a semiconductor device, the method comprising:
during a first cycle, implementing an image display operation including programming the pixel circuit for a valid image and driving the pixel circuit to emit light according to the programming; and
during a second cycle, implementing a recovery operation for recovering a portion of the display aging, the recovery operation including illuminating the semiconductor device while negatively biasing the pixel circuit with a recovery voltage different from an image programming voltage for a valid image.

12. The method of claim 11 in which the illumination is with light in the blue or ultraviolet range.

13. The method of claim 11 in which illuminating the semiconductor device while negatively biasing the pixel circuit with a recovery voltage produces a negative induced VT voltage shift in the semiconductor device.

14. The method of claim 13 in which the negative induced VT shift is followed by a positive induced VT shift to minimize the gap between the performances of different pixel circuits.

15. The method of claim 14 in which the negative induced VT shift and the positive induced VT shift are repeated multiple times.

16. The method of claim 11 in which the illumination is generated by said semiconductor device itself.

17. The method of claim 11 in which the recovery voltage is based on the performance or aging history of the pixel circuit.

18. The method of claim 11 in which the illumination and the recovery voltage are substantially constant.

19. The method of claim 11 in which the illumination and the recovery voltage are pulses.

20. The method of claim 11 in which non-uniformities associated with the plurality of pixels are improved.
